(19) United States
(12) Patent Application Publication
(10) Pub. No.: US 2006/0090402 A1
(43) Pub. Date: May 4, 2006

(54) Polishing composition

(76) Inventor: Yasuhide Uemura, Aichi (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/259,807

(22) Filed: Oct. 27, 2005

(30) Foreign Application Priority Data
Oct. 29, 2004 (JP) 2004-317199

(51) Int. Cl. C09K 3/14

(52) U.S. Cl. 51/308

(57) ABSTRACT

A polishing composition contains colloidal silica, potassium hydroxide, potassium bicarbonate, and water. The content of colloidal silica in the polishing composition is 2 % by mass or more. The average particle size of secondary particles of colloidal silica included in the polishing composition is preferably 60 nm or less. The polishing composition is suitable for use in polishing a semiconductor substrate.

### BACKGROUND OF THE INVENTION

The present invention relates to a polishing composition for use in polishing an object such as semiconductor substrates.

A polishing composition containing colloidal silica has been proposed as such a polishing composition for use in polishing semiconductor substrates such as silicon wafers. However, in such types of polishing compositions, problems arise due to negative effects caused by flocculation of colloidal silica. For example, many surface defects are generated on a semiconductor substrate that has been polished with the polishing composition, and in case of recycling the polishing composition, a filter used for removing polishing chips in the polishing composition that has been used for polishing easily gets clogged. Japanese Laid-Open Patent Publications No. 4-313224 and No. 11-302634 disclose polishing compositions that are improved to avoid such negative effects. However, the polishing compositions of the above publications No. 4-313224 and No. 11-302634 do not sufficiently satisfy the required performance and there is yet room for improvements in the polishing compositions.

### SUMMARY OF THE INVENTION

Accordingly, it is an objective of the present invention to provide a polishing composition that is suitable for polishing, for example, semiconductor substrates.

To achieve the foregoing and other objectives, a polishing composition containing colloidal silica, potassium hydroxide, potassium bicarbonate, and water is provided. The content of colloidal silica in the polishing composition is 2% by mass or more.

The present invention also provides a method including polishing a semiconductor substrate using the above polishing composition.

Further, the present invention provides a method for manufacturing a semiconductor substrate. The method includes: preparing the above polishing composition; and polishing a semi-finished product of the semiconductor substrate using the prepared polishing composition.

Other aspects and advantages of the invention will become apparent from the following description illustrating by way of example the principles of the invention.

### DETAILED DESCRIPTION OF THE PREFERRED EMBODIMENTS

One embodiment of the present invention will now be described.

A polishing composition according to this embodiment contains an abrasive, a processing accelerator, and water.

The abrasive contains at least colloidal silica. Colloidal silica plays the role of mechanically polishing an object.

Colloidal silica of which the average particle size of the secondary particles is less than 10 nm is not so high in ability to polish the object. Therefore, in view of improving the polishing rate, the average particle size of the secondary particles of colloidal silica is preferably 10 nm or more. Meanwhile, when the average particle size of the secondary particles of colloidal silica is greater than 60 nm, or more specifically greater than 40 nm, or even more specifically greater than 30 nm, clogging of a filter is likely to occur and the filter needs to be exchanged frequently. Therefore, in view of preventing clogging of the filter, the average particle size of the secondary particles of colloidal silica is preferably 60 nm or less, and more preferably 40 nm or less, and even more preferably 30 nm or less. The average particle size of the secondary particles of colloidal silica is obtained through, for example, a laser diffraction scattering method.

When the content of colloidal silica in the polishing composition is less than 2% by mass, colloidal silica easily flocculates. As a result, many surface defects are generated on the polished object or the filter gets clogged in a short time. Therefore, in view of preventing flocculation of colloidal silica, the content of colloidal silica in the polishing composition must be 2% by mass or more. Meanwhile, when the content of colloidal silica in the polishing composition is greater than 50% by mass, there is a risk that the stability of the polishing composition could be decreased causing gelation of or deposition in the polishing composition. Therefore, in view of preventing gelation of and deposition in the polishing composition, the content of colloidal silica in the polishing composition is preferably 50% by mass or less.

The flocculation of colloidal silica is caused when the secondary particles of colloidal silica are strongly pressed against one another due to pressure (polishing pressure) applied between a polishing member such as a polishing pad and the object while polishing. Therefore, including a relatively large amount of colloidal silica in the polishing composition is very effective in preventing flocculation of colloidal silica since the pressure applied to each secondary particle is decreased as a result of dispersion of the polishing pressure.

The processing accelerator contains at least potassium hydroxide and potassium bicarbonate. Potassium hydroxide and potassium bicarbonate both promote mechanical polishing performed by colloidal silica and suppress flocculation of colloidal silica. However, potassium hydroxide is superior than potassium bicarbonate in promoting mechanical polishing performed by colloidal silica, and potassium bicarbonate is superior than potassium hydroxide in suppressing flocculation of colloidal silica.

When the total content of potassium hydroxide and potassium bicarbonate in the polishing composition is less than 0.01% by mass, or more specifically less than 0.1% by mass, there is a risk that the polishing composition could not have a high polishing ability since mechanical polishing performed by colloidal silica is not strongly promoted. Therefore, in view of improving the polishing rate, the total content of potassium hydroxide and potassium bicarbonate in the polishing composition is preferably 0.01% by mass or more, and more preferably 0.1% by mass or more. Meanwhile, when the total content of potassium hydroxide and potassium bicarbonate in the polishing composition is greater than 10% by mass, or more specifically 5% by mass, there is a risk that the cost effectiveness could become low and the polishing composition could become uneconomical. Therefore, in view of avoiding decrease in the economical efficiency, the total content of potassium hydroxide and potassium bicarbonate in the polishing composition is preferably 10% by mass or less, and more preferably 5% by mass or less.

When the content (mass percentage) of potassium hydroxide in the polishing composition is less than the content (mass percentage) of potassium bicarbonate in the polishing composition, mechanical polishing performed by colloidal silica is not strongly promoted since the content of potassium hydroxide in the polishing composition is small. As a result, there is a risk that the polishing composition could not have a high polishing ability. Therefore, in view of improving the polishing rate, the content of potassium hydroxide is preferably greater than or equal to the content of potassium bicarbonate. Meanwhile, when the content of potassium hydroxide in the polishing composition is greater than five times the content of potassium bicarbonate in the polishing composition, there is a risk that flocculation of colloidal silica could not be strongly suppressed since the content of potassium bicarbonate in the polishing composition is small. Therefore, in view of strongly suppressing flocculation of colloidal silica, the content of potassium hydroxide is preferably less than or equal to five times the content of potassium bicarbonate.

The water serves as a medium for dispersing or dissolving components other than water in the polishing composition. Water preferably contains as little impurities as possible.

The polishing composition according to this embodiment is for use in, for example, polishing semiconductor substrates such as silicon wafers. In other words, the polishing composition is for use in, for example, polishing semi-finished products to obtain semiconductor substrates as polished products. The surface of the object is polished using the polishing composition, for example, by placing a polishing member such as a polishing pad in contact with the surface of the object, and sliding either the object or the polishing member while feeding the polishing composition into the contact portion.

The preferred embodiment provides the following advantages.

The polishing composition according to this embodiment contains potassium hydroxide and potassium bicarbonate that suppress flocculation of colloidal silica, and the content of colloidal silica in the polishing composition is set to 2% by mass or more. Thus, according to the polishing composition of this embodiment, flocculation of colloidal silica in the polishing composition is reliably suppressed. This reliably suppresses generation of many surface defects on the polished object and clogging of the filter in a short time, which are caused by flocculation of colloidal silica.

When the average particle size of the secondary particles of colloidal silica in the polishing composition is set to 60 nm or less, clogging of the filter that is caused by the inherently large size of the secondary particles of colloidal silica is prevented.

The preferred embodiment may be modified as follows.

The polishing composition according to this embodiment may further contain a chelating agent. The chelating agent forms a complex ion with metal impurities thereby capturing the metal impurities. Therefore, when the chelating agent is added to the polishing composition, the object is suppressed from being contaminated with metal impurities in the polishing composition. The chelating agent to be added preferably captures iron, nickel, copper, calcium, chromium, and zinc effectively. The chelating agent may be, for example, aminocarboxylic acid-based chelating agent such as ethylenediaminetetraacetic acid, diethylenetriaminepentaacetic acid, triethylenetetraminehexaacetic acid, propanediaminetetraacetic acid, and nitrilotriacetic acid.

When the content of the chelating agent in the polishing composition is less than 0.001% by mass, or more specifically less than 0.01% by mass, metal contamination of the object is not suppressed much. Therefore, in view of strongly suppressing metal contamination of the object, the content of the chelating agent in the polishing composition is preferably 0.001% by mass or more, and more preferably 0.01% by mass or more. Meanwhile, when the content of the chelating agent in the polishing composition is greater than 0.2% by mass, or more specifically greater than 0.1% by mass, there is a risk that the cost effectiveness could become low and the polishing composition could become uneconomical. Therefore, in view of avoiding decrease in the economical efficiency, the content of the chelating agent in the polishing composition is preferably 0.2% by mass or less, and more preferably 0.1% by mass or less.

The polishing composition of this embodiment may further contain a water-soluble polymer. The water-soluble polymer acts to improve the wettability of the object. Therefore, when the water-soluble polymer is added to the polishing composition, even if the abrasive adheres to the object, the adhered abrasive is easily removed by simply washing. The water-soluble polymer to be added preferably includes at least one kind selected from a group consisting of hydroxyethyl cellulose, polyvinyl alcohol, polyethylene oxide, and polyethylene glycol, and more preferably consists of hydroxyethyl cellulose. The molecular weight of hydroxyethyl cellulose is preferably 300,000 to 3,000,000, and more preferably 600,000 to 2,000,000. The molecular weight of polyvinyl alcohol is preferably 1,000 to 1,000,000, and more preferably 5,000 to 500,000. The molecular weight of polyethylene oxide is preferably 20,000 to 50,000,000, and more preferably 20,000 to 30,000,000. The molecular weight of polyethylene glycol is preferably 100 to 20,000, and more preferably 300 to 20,000.

When the content of the water-soluble polymer in the polishing composition is less than 0.0001% by mass, or more specifically less than 0.001% by mass, or even more specifically less than 0.005% by mass, the wettability of the object does not improve much. Therefore, in view of improving the wettability of the object, the content of the water-soluble polymer in the polishing composition is preferably 0.0001% by mass or more, and more preferably 0.001% by mass or more, and even more preferably 0.005% by mass or more. Meanwhile, when the content of the water-soluble polymer in the polishing composition is greater than 0.5% by mass, or more specifically greater than 0.3% by mass, or even more specifically greater than 0.15% by mass, there is a risk that the cost effectiveness could become low and the polishing composition could become uneconomical. Therefore, in view of avoiding decrease in the economical efficiency, the content of the water-soluble polymer in the polishing composition is preferably 0.5% by mass or less, and more preferably 0.3% by mass or less, and even more preferably 0.15% by mass or less.

The polishing composition according to this embodiment may be prepared by diluting liquid concentrate with water.

The polishing composition according to this embodiment may be used for polishing an object other than semiconductor substrates.

Next, examples and comparative examples of the present invention will be described.

In examples 1 to 13 and comparative examples 1 to 12, an abrasive, a processing accelerator, and water were mixed, and to the mixture was added a chelating agent, if necessary, to prepare polishing compositions. An abrasive, a processing accelerator, and a chelating agent in each polishing composition used in examples 1 to 13 and comparative examples 1 to 12 are shown in Table 1.

A silicon wafer was polished using each polishing composition of examples 1 to 13 and comparative examples 1 to 12 under a polishing condition shown in Table 2. To determine whether flocculation of the abrasive had occurred in each polishing composition and to determine the degree of flocculation, the average particle size of the secondary particles of colloidal silica in the polishing composition before and after polishing (20 minutes×6 batches) was measured through the laser diffraction scattering method. “N4Plus Submicron Particle Sizer” manufactured by Beckman Coulter was used for measuring the average particle size of the secondary particles through the laser diffraction scattering method. Based on the difference between the average particle size of the secondary particles of colloidal silica in the polishing composition before and after polishing, the polishing compositions were evaluated according to a five rank scale: excellent (1), good (2), acceptable (3), slightly poor (4), and poor (5). That is, when the increase of the average particle size of the secondary particles of colloidal silica after being used for polishing was less than 30 nm, the polishing composition was ranked excellent, when 30 nm or more and less than 40 nm, the polishing composition was ranked good, when 40 nm or more and less than 50 nm, the polishing composition was ranked acceptable, when 50 nm or more and less than 60 nm, the polishing composition was ranked slightly poor, and when 60 nm or more, the polishing composition was ranked poor. The evaluation results are shown in the column entitled “Stability of secondary particle size of colloidal silica” in Table 1.

Based on the cumulative removal thickness after silicon wafers were continuously polished until the feed rate of the polishing composition at 2.0 liters/minute can no longer be maintained due to clogging of the filter, polishing compositions were evaluated according to a five rank scale: excellent (1), good (2), acceptable (3), slightly poor (4), and poor (5). That is, when the cumulative removal thickness was 140 μm or more, the polishing composition was ranked excellent, when it was 130 μm or more and less than 140 μm, the polishing composition was ranked good, when it was 120 μm or more and less than 130 μm, the polishing composition was ranked acceptable, when it was 100 μm or more and less than 120 μm, the polishing composition was ranked slightly poor, and when it was less than 100 μm, the polishing composition was ranked poor. The evaluation results are shown in the column entitled “Preventing degree of filter clogging” in Table 1.

TABLE 1

| | | Processing | Chelating | Stability of | Preventing |
|---|---|---|---|---|---|
| | Abrasive | accelerator | agent | secondary | degree of |
| | [mass | [mass | [mass | particle size of | filter |
| | percentage] | percentage] | percentage] | colloidal silica | clogging |
| Ex. 1 | colloidal | KOH/KHCO₃ | TTHA | 1 | 1 |
| | silica*¹ 10% | 0.5%/0.25% | 0.15% | | |
| Ex. 2 | colloidal | KOH/KHCO₃ | TTHA | 1 | 1 |
| | silica*¹ 5% | 0.25%/0.125% | 0.075% | | |
| Ex. 3 | colloidal | KOH/KHCO₃ | TTHA | 1 | 1 |
| | silica*¹ 3% | 0.15%/0.075% | 0.045% | | |
| Ex. 4 | colloidal | KOH/KHCO₃ | TTHA | 2 | 1 |
| | silica*¹ 2% | 0.1%/0.05% | 0.03% | | |
| Ex. 5 | colloidal | KOH/KHCO₃ | TTHA | 3 | 2 |
| | silica*¹ 2.5% | 0.25%/0.125% | 0.45% | | |
| Ex. 6 | colloidal | KOH/KHCO₃ | TTHA | 1 | 3 |
| | silica*² 3% | 0.15%/0.075% | 0.45% | | |
| Ex. 7 | colloidal | KOH/KHCO₃ | TTHA | 2 | 1 |
| | silica*¹ 3% | 0.15%/0.03% | 0.45% | | |
| Ex. 8 | colloidal | KOH/KHCO₃ | TTHA | 3 | 1 |
| | silica*¹ 3% | 0.15%/0.15% | 0.45% | | |
| Ex. 9 | colloidal | KOH/KHCO₃ | TTHA | 2 | 2 |
| | silica*¹ 3% | 0.15%/0.3% | 0.45% | | |
| Ex. 10 | colloidal | KOH/KHCO₃ | — | 1 | 1 |
| | silica*¹ 3% | 0.15%/0.075% | | | |
| Ex. 11 | colloidal | KOH/KHCO₃ | DTPA | 1 | 1 |
| | silica*¹ 3% | 0.15%/0.075% | 0.45% | | |
| Ex. 12 | colloidal | KOH/KHCO₃ | TTHA | 1 | 4 |
| | silica*³ 3% | 0.15%/0.075% | 0.45% | | |
| Ex. 13 | colloidal | KOH/KHCO₃ | TTHA | 1 | 5 |
| | silica*⁴ 3% | 0.15%/0.075% | 0.45% | | |
| C. Ex. 1 | colloidal | KOH/KHCO₃ | TTHA | 4 | 4 |
| | silica*¹ 1% | 0.05%/0.025% | 0.15% | | |
| C. Ex. 2 | colloidal | KOH/KHCO₃ | TTHA | 4 | 5 |
| | silica*¹ 1.5% | 0.15%/0.075% | 0.45% | | |
| C. Ex. 3 | colloidal | KOH | TTHA | 4 | 2 |
| | silica*¹ 3% | 0.15% | 0.45% | | |
| C. Ex. 4 | colloidal | NaOH/NaHCO₃ | TTHA | 4 | 2 |
| | silica*¹ 3% | 0.15%/0.06% | 0.45% | | |
| C. Ex. 5 | colloidal | NaOH | TTHA | 4 | 2 |
| | silica*¹ 3% | 0.15% | 0.45% | | |
| C. Ex. 6 | colloidal | KOH/KH₄HCO₃ | TTHA | 5 | 2 |
| | silica*¹ 3% | 0.15%/0.06% | 0.45% | | |
| C. Ex. 7 | colloidal | KOH/(KH₄)₂CO₃ | TTHA | 5 | 2 |
| | silica*² 3% | 0.15%/0.075% | 0.45% | | |
| C. Ex. 8 | colloidal | KOH/K₂CO₃ | TTHA | 5 | 2 |
| | silica*¹ 3% | 0.15%/0.105% | 0.45% | | |
| C. Ex. 9 | colloidal | KOH/TMAH | TTHA | 5 | 4 |
| | silica*¹ 3% | 0.15%/0.015% | 0.45% | | |
| C. Ex. 10 | colloidal | TMAH | TTHA | 5 | 4 |
| | silica*¹ 3% | 0.015% | 0.45% | | |
| C. Ex. 11 | colloidal | KOH/piperazine | TTHA | 5 | 5 |
| | silica*¹ 3% | 0.15%/0.015% | 0.45% | | |
| C. Ex. 12 | colloidal | piperazine | TTHA | 5 | 5 |
| | silica*¹ 3% | 0.015% | 0.45% | | |

TABLE 2

Object to be polished: 16 p++-type silicon wafers each
having a diameter of 6 inches (about 150 mm) per one batch
Polishing machine: Single sided polishing machine “SPM-15”
manufactured by Fujikoshi Machinery Corp.
Polishing load: 31.5 kPa
Rotation speed of surface plate: 60 rpm
Rotation speed of head: 120 rpm
Polishing time: 20 minutes × 12 batches
Polishing pad: “Suba800”; manufactured by Rodel Inc.
Feed rate of polishing composition: 2.0 liters/minute (recycled)
Amount of polishing composition used: 40 liters
Filter: A filter having pore size of 10 μm manufactured by
Pall Corporation
Temperature of polishing composition: 30° C.
pH of polishing composition while polishing: adjust to 10.5 pH
using KOH (NaOH for comparative examples 4 and 5, TMAH for
comparative example 11, piperazine for comparative example 12)

In the column entitled “Abrasive” in Table 1, “colloidal silica *¹”represents colloidal silica in which the average particle size of the secondary particles is 25 nm, “colloidal silica *²”, represents colloidal silica in which the average particle size of the secondary particles is 50 nm, “colloidal silica *³” represents colloidal silica in which the average particle size of the secondary particles is 70 nm, and “colloidal silica *⁴” represents colloidal silica in which the average particle size of the secondary particles is 100 nm. In the column entitled “Processing accelerator” in Table 1, “KOH” represents potassium hydroxide, “KHCO₃” represents potassium bicarbonate, “NaOH” represents sodium hydroxide, “NaHCO₃” represents sodium bicarbonate, “NH₄HCO₃” represents ammonium bicarbonate, “(NH₄)₂CO₃” represents diammonium carbonate, and “TMAH” represents tetramethylammonium hydroxide. In the column entitled “Chelating agent” in Table 1, “TTHA” represents triethylenetetraminehexaacetic acid, and “DTPA” represents diethylenetriaminepentaacetic acid.

As shown in Table 1, any of the evaluations for the stability of the secondary particle size of colloidal silica in examples 1 to 13 were either acceptable, good, or excellent. Contrastingly, the evaluations for the stability of the secondary particle size of colloidal silica in comparative examples 1 to 12 were either poor or slightly poor. The results suggest that the polishing compositions of the present invention reliably suppress flocculation of colloidal silica. In examples 1 to 11, any of the evaluations for “Preventing degree of filter clogging” were either acceptable, good, or excellent. The results suggest that clogging of the filter is suppressed by setting the average particle size of the secondary particles of colloidal silica to 60 nm or less.

Although data is not shown, any of the polishing compositions of examples 1 to 13 and comparative examples 1 to 12 had sufficiently high polishing rate. This is because, for example, potassium hydroxide was added to the polishing compositions so as to maintain the pH of the polishing compositions at 10.5 while polishing. For example, if potassium hydroxide is removed from the composition of the polishing composition of example 3, the pH of the polishing composition will decrease while polishing. Thus, the polishing rate will not be sufficient for a practical level.

1. A polishing composition comprising colloidal silica, potassium hydroxide, potassium bicarbonate, and water, wherein the content of colloidal silica in the polishing composition is 2% by mass or more.

2. The polishing composition according to claim 1, wherein the average particle size of secondary particles of colloidal silica is 60 nm or less.

3. The polishing composition according to claim 1, wherein the content of potassium hydroxide in the polishing composition is greater than or equal to the content of potassium bicarbonate in the polishing composition and less than five times the content of potassium bicarbonate in the polishing composition.

4. The polishing composition according to claim 1, wherein the total content of potassium hydroxide and potassium bicarbonate in the polishing composition is 0.01 to 10% by mass.

5. The polishing composition according to claim 1, further comprising a chelating agent.

6. The polishing composition according to claim 1, further comprising a water-soluble polymer.

7. The polishing composition according to claim 6, wherein the water-soluble polymer includes at least one kind selected from a group consisting of hydroxyethyl cellulose, polyvinyl alcohol, polyethylene oxide, and polyethylene glycol.

8. The polishing composition according to claim 1, wherein the polishing composition is used for polishing a semiconductor substrate.

9. A method comprising polishing a semiconductor substrate using a polishing composition containing colloidal silica, potassium hydroxide, potassium bicarbonate, and water, wherein the content of colloidal silica in the polishing composition is 2% by mass or more.

10. A method for manufacturing a semiconductor substrate, comprising:
preparing a polishing composition containing colloidal silica, potassium hydroxide, potassium bicarbonate, and water, wherein the content of colloidal silica in the polishing composition is 2% by mass or more; and
polishing a semi-finished product of the semiconductor substrate using the prepared polishing composition.
